(19) United States
(12) Patent Application Publication
(10) Pub. No.: US 2008/0226904 A1
(43) Pub. Date: Sep. 18, 2008

(54) LINERLESS TWO-SIDED ADHESIVE TAPE

(75) Inventor: Edward J. Killey, Syracuse, NY (US)

Correspondence Address: BOND, SCHOENECK & KING, PLLC, ONE LINCOLN CENTER, SYRACUSE, NY, 13202-1355, US

(73) Assignee: PCI PAPER CONVERSIONS, INC., Syracuse, NY (US)

(21) Appl. No.: 12/045,444

(22) Filed: Mar. 10, 2008

Related U.S. Application Data
(60) Provisional application No. 60/893,770, filed on Mar. 8, 2007.

(51) Int. Cl. B32B 7/12

(52) U.S. Cl. 428/343

(57) ABSTRACT

A linerless two-sided adhesive tape made of a translucent vellum that is coated with a primer formulated to bond adhesives tightly to the paper. The adhesive consists of a microsphere formulation applied via a gravure-transfer method. The adhesive is comprised of discreet, internally crosslinked, solid spheres of acrylic adhesive, generally in 20 to 50 microns in diameter. The coating process results in random but consistent patterns of microspheres laid out in short lines. The linerless two-sided tape can also be prepared with different microsphere adhesive formulations for increased tackiness or differential adhesion levels from one side to the other. Color dispersions added to the primer or adhesives may be used to change the appearance of the tape if desired.

### CROSS-REFERENCE TO RELATED APPLICATIONS

The present invention application claims priority to U.S. Provisional Application No. 60/893,770, filed on Mar. 8, 2007.

### BACKGROUND OF THE INVENTION

1. Field of the Invention

The present invention relates to adhesive tape and, more particularly, to a two-sided adhesive tape that does not require a liner.

2. Description of the Related Art

A tape comprised of repositionable adhesive on both faces of the substrate is wound onto itself and can be unwound subsequently without the need for a releasable liner. Such tape can be used for the mounting of articles such as photos, cards and other mementos into scrapbooks. The repositionable adhesive layers permit removal and repositioning of the mounted article. This tape may also be used to affix other articles such as letters, posters, memos, etc, to walls or other vertical surfaces and can be removed at a later date without leaving residue or discoloration.

Currently, mounting tapes are supplied with a releasable liner to keep opposing adhesive layers from bonding to each other. The use of the liner adds cost to the product and reduces the amount of material that can be supplied in a rolled product that would be placed in a tape dispenser. The liner must be discarded after dispensing a length of the mounting tape.

### BRIEF SUMMARY OF THE INVENTION

It is therefore a principal object and advantage of the present invention to provide a linerless two-sided adhesive tape.

In accordance with the foregoing objects and advantages, the present invention provides a linerless two-sided adhesive tape comprising a layer of translucent vellum having a first coating of a primer formulated to bond adhesives tightly to the paper, and a second overlying coating of an adhesive. The adhesive comprises formulations of microspheres applied via a gravure-transfer method, or any contiguous coating method. The adhesive is comprised of discreet, internally crosslinked, solid microspheres of acrylic adhesive, generally in 20 to 50 microns in diameter. The coating process results in random but consistent patterns of microspheres laid out in short lines or domains of microsphere clusters. The spheres will adhere to others adjacent in the wrapped configuration but do not deform or flow into each other. The primer anchors the base of each sphere to the paper so they remain in their coated positions during unwinding. As the wrap of tape unwinds, the contacting spheres yield from each other yet remain attached to the paperstock.

### BRIEF DESCRIPTION OF THE DRAWINGS

The present invention will be more fully understood and appreciated by reading the following Detailed Description in conjunction with the accompanying drawings, in which:

FIG. 1A is a high-level schematic of a linerless two-sided adhesive tape according to the present invention; and

FIG. 1B is a schematic of a linerless two-sided adhesive tape showing a portion of FIG. 1A in closer detail.

### DETAILED DESCRIPTION OF THE INVENTION

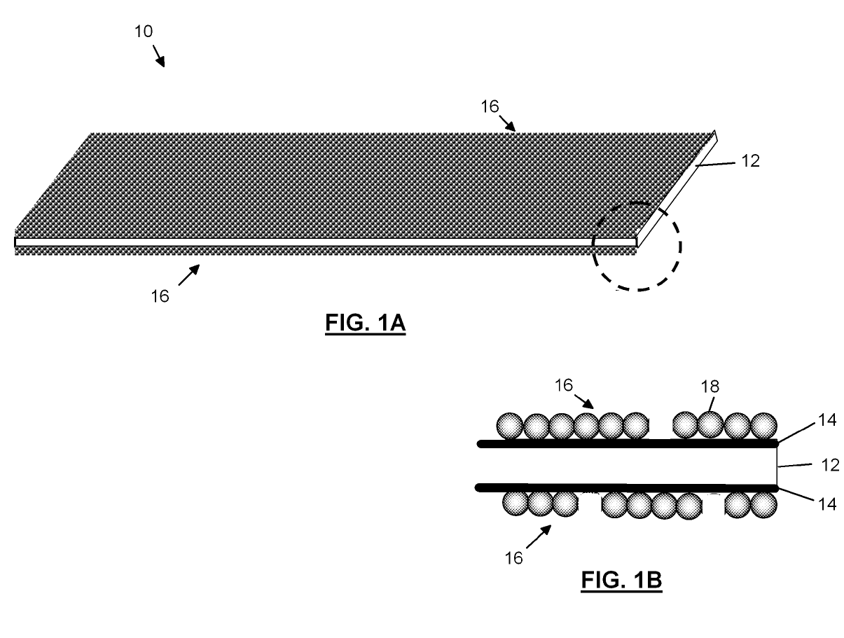

Referring now to the drawings, wherein like reference numerals refer to like parts throughout, there is seen in FIGS. 1A and 1B a linerless two-sided adhesive tape 10 comprising a substrate 12, a primer 14 positioned on both sides of the substrate 12, and a microsphere adhesive 16 formulation bonded to primer 14.

Tape substrate 12 is preferably translucent vellum paper of thirty pound grade that is selected for its strength to withstand multiple coating passes, rewindings and unwindings. Alternatively, tape substrate 12 may comprise filmic substrates such as polyester, polypropylene, vinyl. Woven and non-woven fabrics may also be used. Vellum, being paper, possesses the desired ability to easily be torn in preferred lengths.

Substrate 12 paper is coated with primer 14 formulated to bond adhesives 16 tightly to paper substrate 12. Primer 14 may be a composition of a binding polymer, such as acrylic, urethane, polyvinyl alcohol (PVOH), combined with earthen filler, such as silicon dioxide, calcium carbonate, and zinc oxide. The microspheres of microsphere adhesive 16 may be applied with a carrier polymer that will bond the microspheres to the substrate upon drying, such as an acrylic polymer adhesive in a fluid state, i.e., a conventional non-microsphere acrylic adhesive emulsion.

Microsphere adhesive 16 formulation is applied to paper substrate 12 via a gravure-transfer method commonly used in the coating industry. Other coating methods for continuous application are useful as well, such as shot die, wire-wound rod, and rotary screen. Paper substrate 12 is then wound into a roll and returned to the coating machine for the same coating sequence applied to the other side of paper substrate 12. Preferably, a coating process will coat both sides of substrate 12 in a single pass through a coating machine using multiple coating stations. The completed roll of linerless two-sided tape 10 can then be converted into finished rolls of variable widths and lengths.

Linerless two-sided tape 10 can also be prepared with different microsphere adhesive 16 formulations for increased tackiness or differential adhesion levels from one side to the other. Color dispersions added to primer 14 or adhesives 16 may be used to change the appearance of the tape if desired.

The ability of linerless two-sided tape 10 to be releasable from itself without pulling adhesive from one face to the other is derived from two aspects of adhesive 16 and the coating process. Adhesive 16 is preferably comprised of discreet, internally crosslinked, solid spheres 18 of acrylic adhesive, generally in 20 to 50 microns in diameter. The spheres 18 will stick to adjacent spheres 18 in the wrapped configuration, but do not deform or flow into each other. Primer 14 anchors the base of each sphere 18 to paper substrate 12 so they remain in their coated positions during unwinding. As the wrap of paper substrate 12 unwinds, contacting spheres 18 yield from each other yet remain attached to paper substrate 12.

The coating process takes advantage of spheres 18 tendency to form random but consistent patterns of spheres 18 laid out in short lines. The patterns are called “crow's feet” based on their appearance and are normally considered to be an undesirable coating effect. The normally undesirable trait of crow's feet is the result of larger uncoated or unoccupied areas of substrate 12 that are devoid of microspheres. When two coated pieces of paper substrate 12 are placed against each other such as in winding, the majority of spheres 18 will naturally align themselves in the larger open spaces between the lines of the crow's feet pattern of spheres 18. Other geometric arrangements that may suffice for the present invention include the inclusion of microspheres having differing diameters for each side of tape 10 or a random dispersion of varying diameter microspheres, either of which will assist in reducing contact between opposing microspheres. The open spaces where primer 14 would be present may be thinly covered by other materials in the adhesive formulation, such as a thickener or traditional acrylic polymer used as a coating carrier for adhering microspheres. Therefore, with fewer spheres 18 contacting each other, the force to peel paper substrate 12 away from itself is reduced.

Other configurations such as pattern-coated adhesives, different substrates, converted assemblies other than tapes, such as pads, or various polymers will come to mind to those knowledgeable and practiced in coatings and converting.

What is claimed is:

1. An adhesive tape, comprising:
a substrate having first and second sides;
a first layer of a first microsphere adhesive bound to the first side of said substrate; and
a second layer of a second microsphere adhesive bound to said second side of said substrate.

2. The tape of claim 1, further comprising a first primer binding said first microsphere adhesive to the first side of said substrate.

3. The tape of claim 2, wherein said first microsphere adhesive comprises solid spheres of cross-linked acrylic.

4. The tape of claim 3, wherein the solid spheres of said first microsphere adhesive are between about 20 and about 50 microns in diameter.

5. The tape of claim 4, wherein the solid spheres of said first microsphere adhesive are distributed on said first side of said substrate in a crow's feet pattern.

6. The tape of claim 5, further comprising a second primer binding said second microsphere adhesive to the second side of said substrate.

7. The tape of claim 6, wherein said second microsphere adhesive comprises solid spheres of cross-linked acrylic.

8. The tape of claim 7, wherein the solid spheres of said second microsphere adhesive are between about 20 and about 50 microns in diameter.

9. The tape of claim 8, wherein the solid spheres of said second microsphere adhesive are distributed on said second side of said substrate in a crow's feet pattern.

10. The tape of claim 9, wherein the substrate is vellum.

11. The tape of claim 10, wherein the vellum is transparent.

12. An adhesive tape, comprising:
a substrate having first and second sides;
a first layer of a microsphere adhesive comprising solid spheres of cross-linked acrylic having a diameter of between about 20 and about 50 microns bound to the first side of said substrate by a primer; and
a second layer of said microsphere adhesive bound to the second side of said substrate by said primer.
